(19) United States
(12) Patent Application Publication
(10) Pub. No.: US 2025/0317310 A1
(43) Pub. Date: Oct. 9, 2025

(54) METHOD AND APPARTUS FOR SECURING MEDIA CONTENT USING LAZY MINTING OF BLOCKCHAIN, IPFS AND DIGITAL WATERMARKING

(71) Applicant: APOT Platforms Inc., Yongin-si (KR)

(72) Inventor: Sang Yoon HA, Yongin-si (KR)

(21) Appl. No.: 19/169,180

(22) Filed: Apr. 3, 2025

(30) Foreign Application Priority Data
Apr. 3, 2024 (KR) 10-2024-0045094

(51) Int. Cl. H04L 9/00

(52) U.S. Cl. CPC H04L 9/50

(57) ABSTRACT

A method of securing media content by using lazy minting of a blockchain, an interplanetary file system (IPFS), and a digital watermark, performed by a computing device, includes uploading content to an IPFS-based shared network, obtaining content identification information according to IPFS uploading of the content, applying the content identification information to the content, and determining non-fungible token (NFT) address information by minting the content to which the content identification information is applied.

### CROSS-REFERENCE TO RELATED APPLICATION

This application claims priority to Korean Patent Application No. 10-2024-0045094, filed on Apr. 3, 2024, and all the benefits accruing therefrom under 35 U.S.C. § 119, the contents of which in its entirety are herein incorporated by reference.

### BACKGROUND

### 1. Field

The present disclosure relates to a method and apparatus for securing media content by using lazy minting of a blockchain, an interplanetary file system (IPFS), and a digital watermark.

### 2. Description of the Related Art

Recently, with the development blockchain technology, non-fungible token (NFT) technology that verifies authenticity has been developed. An NFT may be implemented by recording a transaction of a distinguishable token for each unit on a blockchain and connecting the token with external data. It may be impossible to manipulate an NFT for specific data because a connected token is recorded on a blockchain in a distributed fashion, and actual specific data may be authenticated as original data by checking the NFT.

### RELATED LITERATURES

### Patent Literatures

(Patent Literature 1) Korean Patent Application Publication No. 10-2023-0149118

### SUMMARY

The present disclosure is directed to providing a method and apparatus for generating a non-fungible token (NFT) by using interplanetary file system (IPFS)-based lazy minting to prevent forgery and loss of original content and permanently ensure ownership and authenticity of the NFT.

The objectives of the specification are not limited thereto and may be extended to various matters that may be derived by embodiments of the present disclosure described below.

In one aspect, a method of securing media content by using lazy minting of a blockchain, an interplanetary file system (IPFS), and a digital watermark, performed by a computing device, includes uploading content to an IPFS-based shared network, obtaining content identification information according to IPFS uploading of the content, applying the content identification information to the content, and determining non-fungible token (NFT) address information by minting the content to which the content identification information is applied.

In a preferred embodiment, before the uploading, the method may further include generating content for proof of ownership by applying temporary NFT address information obtained through lazy minting to the content, wherein the content for proof of ownership is uploaded to the IPFS.

In a preferred embodiment, the content identification information may include address information on an IPFS network configured according to hash conversion of the content for proof of ownership.

In a preferred embodiment, the content for proof of ownership may include invisible code information applied to an object of the content.

In a preferred embodiment, the content for proof of ownership may be configured by inserting the temporary NFT address information and invisible code information configured from first content into the content.

In a preferred embodiment, the determining of the NFT address information by minting the content to which the content identification information is applied may include determining a final NFT address by performing minting based on identification information generated by uploading the content for proof of ownership to the IPFS.

In addition, the method according to an embodiment of the present disclosure may be combined with hardware and implemented as a computer program stored in a computer-readable medium to execute the method.

According to an embodiment of the present disclosure, according to lazy minting, as first non-fungible token (NFT) address information of an NFT of first content pre-issued by a signature of a first owner is processed into original and unique content for proof of ownership and is uploaded to an interplanetary file system (IPFS)-based shared network, unique content identification information may be obtained, and as minting is performed by using the unique content identification information, verification of ownership may be performed.

In an example, the present disclosure may provide a method and apparatus for generating an NFT by using IPFS-based lazy minting to prevent forgery and loss of original content and permanently ensure ownership and authenticity of the NFT.

The effects of the specification are not limited thereto and may be extended to various content that may be derived from the detailed description of the following embodiments of the present disclosure.

### BRIEF DESCRIPTION OF THE DRAWINGS

FIG. 1 is a diagram illustrating an example of an operating environment of a system according to an embodiment of the specification.

FIG. 2 is a block diagram for describing an internal configuration of a computing device 200 according to an embodiment of the specification.

FIG. 3 is a diagram illustrating a method of generating and managing a non-fungible object (NFO) according to an embodiment of the specification.

FIG. 4 is a flowchart for describing a method of issuing a non-fungible token (NFT) which prevents forgery of original content according to an embodiment of the present disclosure.

FIG. 5 is a flowchart for describing a method of issuing an NFT which prevents forgery of original content according to an embodiment of the present disclosure.

FIG. 6 is a diagram for describing a process according to lazy minting of lazy first content and interplanetary file system (IPFS) application according to an embodiment of the present disclosure.

FIG. 7 is a diagram illustrating a method of managing an original NFT and an additional NFT through a service platform according to an embodiment of the specification.

FIG. 8 is a diagram schematically illustrating each step of FIG. 4.

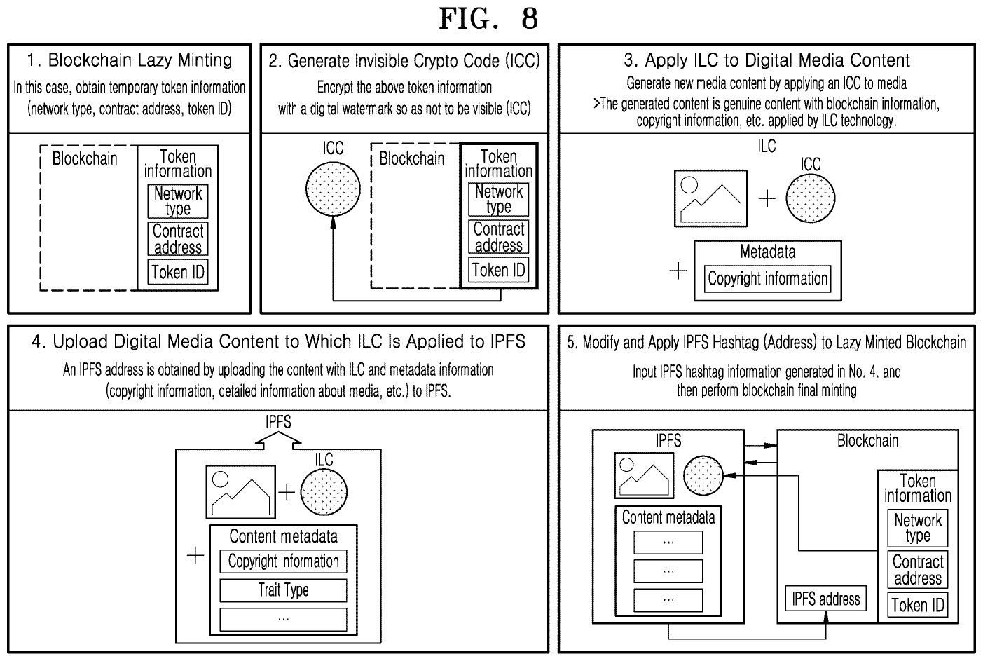

### DETAILED DESCRIPTION

In describing an embodiment of the present disclosure, when a certain detailed description of well-known elements or functions is determined to make the subject matter of an embodiment of the present disclosure ambiguous, the detailed description is omitted. Additionally, in the drawings, elements irrelevant to the description of an embodiment of the present disclosure are omitted, and like reference signs are affixed to like elements.

In an embodiment of the present disclosure, when an element is referred to as being “connected”, “coupled” or “linked” to another element, this may include not only a direct connection relationship but also an indirect connection relationship in which intervening elements are present. Additionally, unless expressly stated to the contrary, “comprise” or “include” when used in this specification, specifies the presence of stated elements but does not preclude the presence or addition of one or more other elements.

In an embodiment of the present disclosure, the terms “first”, “second” and the like are used to distinguish an element from another, and do not limit the order or importance between elements unless otherwise mentioned. Accordingly, a first element in an embodiment may be referred to as a second element in other element within the scope of embodiments of the present disclosure, and likewise, a second element in an embodiment may be referred to as a first element in other embodiment.

In an embodiment of the present disclosure, the distinguishable elements are intended to clearly describe the feature of each element, and do not necessarily represent the separated elements. That is, a plurality of elements may be integrated into one hardware or software, and an element may be distributed to multiple hardware or software. Accordingly, although not explicitly mentioned, the integrated or distributed embodiment is included in the scope of embodiments of the present disclosure.

In the specification, a network may be a concept including a wired network and a wireless network. In this instance, the network may refer to a communication network that allows data exchange between a device and a system and between devices, and is not limited to a particular network.

The embodiment described herein may have aspects of entirely hardware, partly hardware and partly software, or entirely software. In the specification, “unit”, “apparatus” or “system” refers to a computer related entity such as hardware, a combination of hardware and software, or software. For example, the unit, module, apparatus or system as used herein may be a process being executed, a processor, an object, an executable, a thread of execution, a program and/or a computer, but is not limited thereto. For example, both an application running on a computer and the computer may correspond to the unit, module, apparatus or system used herein.

Additionally, the device as used herein may be a mobile device such as a smartphone, a tablet PC, a wearable device and a Head Mounted Display (HM D) as well as a fixed device such as a PC or an electronic device having a display function. Additionally, for example, the device may be an automotive cluster or an Internet of Things (IoT) device. That is, the device as used herein may refer to devices on which the application can run, and is not limited to a particular type. In the following description, for convenience of description, a device on which the application runs is referred to as the device.

In the present disclosure, there is no limitation in the communication method of the network, and a connection between each element may not be made by the same network method. The network may include a communication method using a communication network (for example, a mobile communication network, a wired Internet, a wireless Internet, a broadcast network, a satellite network, etc.) as well as near-field wireless communication between devices. For example, the network may include all communication methods that enable networking between objects, and is not limited to wired communication, wireless communication, 3G, 4G, 5G, or any other methods. For example, the wired and/or wireless network may refer to a communication network by at least one communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VoIP), LTE Advanced, IEEE 802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) or communication using ultrasonic waves, but is not limited thereto.

The elements described in a variety of embodiments are not necessarily essential, and some elements may be optional. Accordingly, an embodiment including some of the elements described in the embodiment is also included in the scope of embodiments of the present disclosure. Additionally, in addition to the elements described in a variety of embodiments, an embodiment further including other elements is also included in the scope of embodiments of the present disclosure.

Hereinafter, embodiments of the present disclosure will be described in detail with reference to the accompanying drawings.

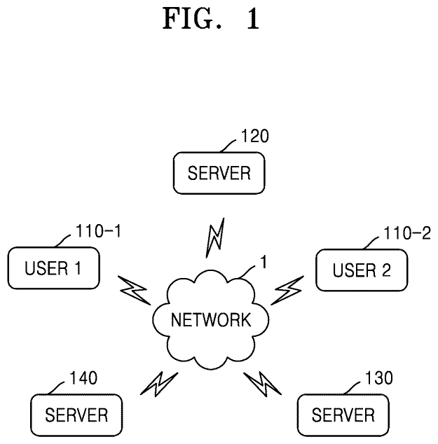

FIG. 1 is a diagram showing an example of a working environment of a system according to an embodiment of the present disclosure. Referring to FIG. 1, a user device 110 and one or more servers 120, 130, 140 are connected via a network 1. FIG. 1 is provided by way of example, and the number of user devices or servers is not limited thereto.

The user device 110 may be a fixed or mobile terminal implemented as a computer system. The user device 110 may include, for example, a smart phone, a mobile phone, a navigation, a computer, a laptop computer, a digital broadcasting terminal, a Personal Digital Assistant (PDA), a Portable Multimedia Player (PMP), a tablet PC, a game console, a wearable device, an internet of things (IoT) device, a virtual reality (VR) device and an augmented reality (AR) device. For example, in the embodiments, the user device 110 may refer to, in substance, one of a variety of physical computer systems that can communicate with the servers 120-140 via the network 1 using a wireless or wired communication method.

Each server may be implemented as a computer device or a plurality of computer devices which provide instructions, code, files, content and services by communication with the user device 110 via the network 1. For example, the server may be a system which provides each service to the user device 110 connected via the network 1. As a more specific example, through an application as a computer program installed and running on the user device 110, the server may provide the user device 110 with a service (for example, information provision, etc.) intended by the corresponding application. As another example, the server may distribute files for installing and running the above-described application to the user device 110, receive user input information and provide a corresponding service.

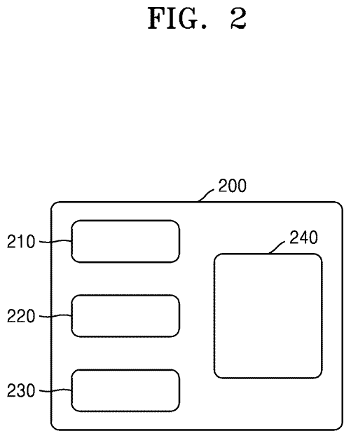

FIG. 2 is a block diagram illustrating the internal configuration of a computing device 200 in an embodiment of the present disclosure. The computing device 200 may be applied to the user device 110 or the servers 120-140 described above with reference to FIG. 1, and each device and the servers may have identical or similar internal configuration by adding or subtracting some components.

Referring to FIG. 2, the computing device 200 may include a memory 210, a processor 220, a communication module 230 and a transmitter/receiver 240. The memory 210 is a non-transitory computer-readable recording medium, and may include a permanent mass storage device such as random access memory (RAM), read only memory (ROM), disk drive, solid state drive (SSD) and flash memory. Here, the permanent mass storage device such as ROM, SSD, flash memory and disk drive is a separate permanent storage device that is different from the memory 210 and may be included in the above-described device or server. Additionally, the memory 210 may store an operating system and at least one program code (for example, code for browsers installed and running on the user device 110 or applications installed on the user device 110 to provide particular services). These software components may be loaded from a separate computer-readable recording medium that is different from the memory 210. The separate computer-readable recording medium may include a computer-readable recording medium such as floppy drive, disk, tape, DVD/CD-ROM drive and a memory card.

In another embodiment, the software components may be loaded onto the memory 210 through the communication module 230, but not the computer-readable recording medium. For example, at least one program may be loaded onto the memory 210 based on a computer program (for example, the above-described application) installed by files provided by developers or a file distribution system (for example, the above-described server) responsible for distributing an installation file of the application via the network 1.

The processor 220 may be configured to process the instructions of the computer program by performing basic operations such as arithmetic, logic and input/output operations. The instructions may be provided to the processor 220 by the memory 210 or the communication module 230. For example, the processor 220 may be configured to execute the received instructions according to the program code stored in the recording device such as the memory 210.

The communication module 230 may provide a function of allowing the user device 110 and the servers 120-140 to communicate with each other via the network 1, and a function of allowing each of the device 110 and/or the servers 120-140 to communicate with another electronic device.

The transmitter/receiver 240 may be a means for interfacing with an external input/output device (not shown). For example, the external input device may include a keyboard, a mouse, a microphone and a camera, and the external output device may include a display, a speaker and a haptic feedback device.

As another example, the transmitter/receiver 240 may be a means for interfacing with a device having an integrated function for input and output such as a touchscreen.

Additionally, in other embodiments, the computing device 200 may include a larger number of components than the components of FIG. 2 according to the nature of a device to which the computing device 200 is applied. For example, when the computing device 200 is applied to the user device 110, the computing device 200 may be implemented to include at least some of the above-described input/output devices, or may further include other components such as a transceiver, a Global Navigation Satellite System (GNSS) module, a camera, a variety of sensors and a database. As a more specific example, when the user device is a smartphone, the computing device 200 may be implemented to further include various types of components commonly included in smartphones, such as an acceleration sensor or a gyro sensor, a camera module, a variety of physical buttons, buttons using a touch panel, input/output ports and a vibrator for vibration.

The computing device 200 described above may be realized by a device including a processor and a memory. The memory may store instructions, and the processor may perform the operations described hereinafter based on the instructions stored in the memory. The device according to the present disclosure may be implemented by at least a part of the configuration illustrated in FIG. 1 or FIG. 2.

A computing device 200 operating based on FIGS. 1 and 2 will now be described. Here, the computing device 200 may be a device that recognizes an object (real or virtual) and performs communication with a service platform through a network. That is, the object may be an object existing in a real space, or may include a two, three, or more-dimensional virtual object existing in a virtual space. That is, a digital image file or a video as a virtual object, or a specific object included in them may be included in the virtual object. Also, a server may be configured to establish a service platform and provide a service through the service platform. In still another example, the server may be configured to establish a trading platform described below and provide a service through the trading platform, but is not limited to a specific form. That is, the server may mange and control a platform provided to a device, but may not be limited thereto.

The present disclosure may be implemented by a device including a processor and a memory, and the memory may store a command. The processor may perform an operation described below based on the command stored in the memory. The device of the present disclosure may be implemented by at least some of components described with reference to FIG. 1 or 2.

In this specification, the following terms are defined for clarity:

Non-Fungible Object (NFO) refers to a tangible or intangible object that is uniquely identifiable and verifiable via blockchain linkage. It is associated with an NFT and is used for original verification of the object.

Invisible Code (IC) refers to a physical or digital identifier applied to the surface or metadata of an object, which is invisible to the human eye but uniquely identifies the object. The IC may be printed, coated, or laser-engraved onto a physical object, or may be embedded into digital content as a watermark or metadata element.

Invisible Link Code (ILC) refers to a blockchain-linked identifier derived from the IC. The ILC may be the same as the IC or may be generated based on a transformation or hash of the IC, and it serves as a blockchain-recognizable identity key for the NFO.

Lazy Minting refers to a cost-saving NFT issuance technique where the NFT is not immediately minted on the blockchain upon creation of the content, but is instead registered and minted at the time of actual transaction. This reduces unnecessary gas fees typically associated with content generation.

Temporary NFT Address is an address allocated during the lazy minting process, representing a placeholder or pre-mint registration of the NFT. It may include token metadata such as network type, contract address, and a reserved token ID.

Original NFT is the primary NFT associated with the NFO. It represents the ownership and authenticity of the original object and is typically transferable only upon change of ownership of the object.

Additional NFTs are NFTs derived from or associated with the original NFT, and may correspond to secondary digital contents. These may be independently traded or distributed, and are logically linked to the value and identity of the original NFT.

In still another example, the computing device 200 and the server may be a type of node that operates based on a blockchain (or a blockchain network). For example, the blockchain may be a ledger management technology based on distributed computing technology in which a distributed data storage environment is generated based on a chain-type connection link generated based on a peer-to-peer (P2P) method so that arbitrary modification is impossible and results of data changes are recorded. The distributed data storage environment may be established based on each node related to the blockchain, and the computing device 200 and the server may be any one of the nodes. In a specific example, a transaction occurring based on a non-fungible token (NFT) may be recorded on each of all nodes within the blockchain, which makes arbitrary manipulation impossible. For example, the computing device 200 and the server may include a ledger for data processing such as data generation and change, and may record on the ledger, but may not be limited thereto. Also, for example, the blockchain and an operation based on the blockchain may be set based on a user account. For example, an airdrop based on an NFT or NFT/TOKEN linked to the blockchain may be performed based on the user account. The user account may be linked to each computing device 200, and the information described above may be checked based on the user account. For example, when the user account is newly linked to another computing device 200, the information described above may be checked through the other computing device 200 that is newly linked. That is, the user account may be linked to the computing device 200, but may not be limited to a specific computing device 200 and may not be limited to a type of the computing device 200. In the following, although the computing device 200 receiving a service through a service platform or a trading platform is referred to as a device for convenience of explanation, the present disclosure is not limited thereto. That is, the device may be a device used by each user such as a user, an owner, a buyer, or a seller, and each user may receive a service provided through a service platform or a trading platform through his/her device.

Also, the service platform or the trading platform may be a platform operating based on the server described above. For example, the platform may be controlled by one server. In still another example, the platform may be controlled by a server including a plurality of nodes based on the blockchain and edge computing, but is not limited to a specific form. Although the following will be described based on the service platform and the trading platform for convenience of explanation, the present disclosure may not be limited thereto.

In the specification, an object that may be authenticated as an original by using an NFT may be digital data, and original authentication for a physical real object as an object may be performed by using a visible or invisible code image applied to the physical real object. The original authentication technology of an NFT may be applied to a physical real object as an object, and original authentication for a physical real object such as an artwork or a historical relic may be easy and effective in object management.

Also, lazy minting may be performed as a method for minimizing the issuance cost incurred during a minting process of issuing such an NFT. Lazy minting may involve a protocol that allows the owner of original content to announce the issuance of an NFT in advance through a cryptographic signature and to process the final issuance of the NFT on a blockchain at the time the original content is traded to a third party, rather than immediately issuing the NFT on the blockchain. As a result, because an NFT issuance fee, which was spent every time the original content was created, was modified to be spent only when an actual NFT transaction occurred after creation, an unnecessary transaction fee may be reduced.

When content to which the NFT is finally allocated is content such as an image file linked to a web URL, there was a problem that the NFT itself could not prove or guarantee when the image linked to the URL on the web is modified.

An interplanetary file system (IPFS) is a protocol and includes a peer-to-peer network for sharing and storing data in a distributed file system. The IPFS uses content addressing to identify each file in a global namespace that connects all computing devices. A content identifier (CID) is generated according to hash conversion of content on the web through content addressing, and when a web address is configured by using the CID, web data sharing using the content itself becomes possible.

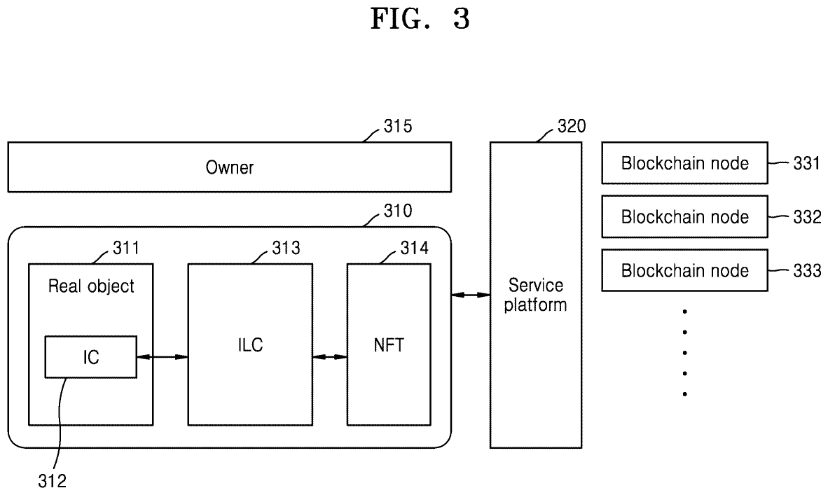

FIG. 3 is a diagram illustrating a method of generating a non-fungible object (NFO) and managing the NFO by using an NFT according to an embodiment of the specification. Referring to FIG. 3, an NFO 310 may be implemented based on an object 311 to which an invisible code (IC) 312 is applied, an invisible link code (ILC) 313, and an NFT 314. For example, the IC 312 may be an invisible code applied to a surface of the object 311. For example, the IC 312 may be applied in an invisible form in various ways, such as being printed or overlapped, on the surface of the object 311, but is not limited to a specific form. The IL C 313 may mean that the IC is recorded (or linked) on a blockchain. That is, an identification code linked to the blockchain linked to the IC 312 in relation to the object 311 may be generated, and the identification code may be the ILC 313. Accordingly, the ILC 313 may be or may not be the same value as the IC 312. In still another example, the ILC 313 may have a value obtained by combining the NFT 314 based on the IC 312, and may not be limited to a specific form. That is, the IC 312 of the object 311 may be linked to the blockchain, and the IL C 313 may be used as a blockchain-based identification code.

In a specific example, the NFO 310 as a non-fungible object may be an object that performs original verification by associating the object 311 with the NFT 314. There may be an owner (or owner account) 315 corresponding to the NFO 310, and the NFO 310 may be connected to a service platform 320 based on the NFT 314. Also, the service platform 320 may store a transaction related to the NFO 310 in a plurality of blockchain nodes 331, 332, 333 based on the NFT 314 in a distributed fashion, thereby performing original authentication on the object 311. For example, in the service platform 320, the NFO 310 may be identified based on the ILC 313.

For example, the object 311 may refer to a physical real object, and its form or shape may not be limited. Although the object 311 is described based on an artwork (painting) for convenience of explanation, the present disclosure is not limited thereto. For example, the object 311 may be a pendent, coin, character, or other physically implemented real object, or a digital file or a specific object or portion included in a digital file, and is not limited to a specific form. The IC 312 may be an invisible crypto code, and may include a material or form that is invisible to human eyes. Accordingly, the IC 312 may not affect the representation of the object 311. For example, an invisible crypto code layer may be applied to the object 311 to implement the object 311 to which the IC 312 is applied. In a more specific example, when the object is a real object, the IC 312 may be scanning, laser, coating, or other methods, and may vary based on a type of the object 311.

For example, when the object 311 is an artwork such as a painting, the IC 312 is an invisible material and may be applied to the object 311 as a unique identification form. In still another example, the IC 312 may be input to the object 311 through a laser based on invisibility, and is not limited to a specific embodiment. Also, in an example, although related content is described based on the NFO 310 as the object 311 to which the IC 312 is applied, the present disclosure may not be limited thereto.

In still another example, one IC 312 may be applied to the NFO 310 or a plurality of ICs 312 may be applied to the NFO 310. For example, when the NFO 310 is a painting, a plurality of ICs 312 may be applied to respective areas of the painting. In still another example, when the NFO 310 is a figure, the ICs 312 may be applied to respective parts of the figure. In the above case, each IC 312 may correspond to each ILC 313, and may not be limited to a specific form. Also, for example, the NFO 310 may further include the ILC 313 associated with the IC 312. For example, the IL C 313 may be the IC 312 itself. That is, the IC 312 may be used as the IL C 313, and thus, may be associated with the NFT 314.

In still another example, the ILC 313 may be a separate identifier generated based on the IC 312. The NFO 310 having a plurality of ICs 312 may generate one ILC 313 by considering the plurality of ICs 312, and may associate the IL C 313 with the NFT 314. That is, the ILC 313 may be a unique identification code for identifying the NFO 310, and may be generated based on the IC 312. Next, the ILC 313 may be associated with the NFT 314. For example, the ILC 313 may be an identifier configured through the IC 312 and the NFT 314.

Also, for example, the NFO 310 may not be manipulated because a transaction of a distinguishable token for each unit is recorded on a blockchain and may prove to be an actual original. The distinguishable token for each unit may be connected to the NFO 310 based on the ILC 313, and thus, original verification for the NFO 310 may be performed. For example, the NFT 314 may be connected to the service platform 320, and original verification for the NFO may be performed by recording a transaction on the plurality of blockchain nodes 331, 332, 333 based on the IL C 313. A blockchain node (or blockchain network) operating through the service platform 320 is not limited to a specific form, and may be irrelevant to a type of the blockchain network. In still another example, a smart contract may be used for the above original verification, and may not be limited to a specific form.

When the NFT 314 is issued as described above, NFT address information may be allocated, managed through the service platform 320, and may be shared through the blockchain. However, the NFT address information may represent content uploaded on a specific web, such as a URL. According to an existing web database processing method, because corresponding content may be modified and changed even when it is the same URL, the NFT 314 may not guarantee permanent proof.

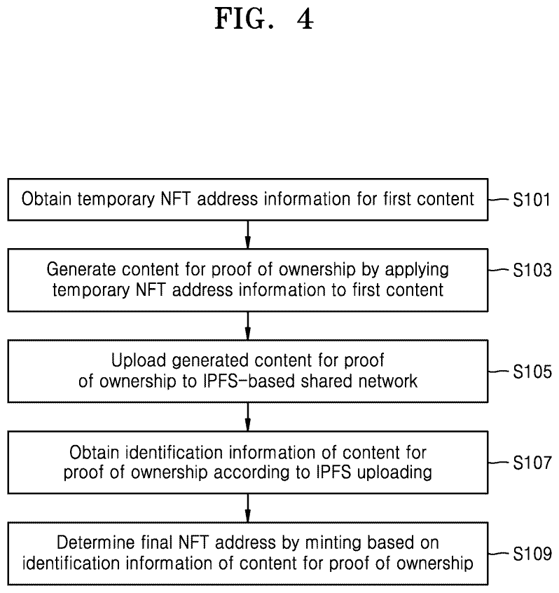

Accordingly, the NFT 314 according to an embodiment of the present disclosure is issued and managed as an NFT that prevents forgery of original content by using lazy minting protocol processing and an IPFS-based shared network system, thereby improving the utilization ad sustainability of a system, which will be described in more detail with reference to FIG. 4.

FIG. 4 is a flowchart for describing a method of issuing an NFT which prevents forgery of original content according to an embodiment of the present disclosure.

Referring to FIG. 4, a computing device 200 according to an embodiment of the present disclosure may obtain temporary NFT address information for first content (S101). The temporary NFT address information may be obtained through lazy minting. The NFT address information is token information, and may include at least one of a network type, a contract address, and a token ID. The temporary NFT address information may be encrypted with a digital watermark (i.e., converted into an IC invisible code form).

Also, in an example, lazy minting is an issuance protocol for issuing an NFT and allows the owner of original content to announce the issuance of an NFT in advance through a cryptographic signature and to process the final issuance of the NFT on a blockchain at the time the original content is traded to a third party, rather than immediately issuing the NFT on the blockchain. Lazy mint is devised to reduce an unnecessary transaction fee by modifying an NFT issuance fee, which was spent every time the original content was created, to be spent only when an actual NFT transaction occurred after creation. In an embodiment of the present disclosure, as lazy minting is used to prove the identity of original content and ownership, higher utilization may be provided.

Next, the computing device 200 may generate content for proof of ownership by applying the temporary NFT address information (or generated IC) to the first content (S103). The first content may be invisible code information (image) or a real or virtual object to which the invisible code information is applied. For example, the content for proof of ownership may be configured by inserting the temporary NFT address information and the invisible code information into the first content, or may be configured by inserting the temporary NFT address information to the invisible code information. The expression ‘being inserted’ may mean being included as meta information in a structure of a first content file or being independently added to URL information for the first content file. For example, a value itself obtained by adding a URL for the first content file and the temporary NFT address or a hash value of the value may be generated as the content for proof of ownership.

Also, in an example, NFTs may be grouped into one collection unit based on the same smart contract, author, or similar content. In this case, users may search for and purchase desired NFTs more easily and conveniently among transaction data and information of NFTs in the collection. As such, when an NFT is issued for content included in one collection, lazy minting may be performed only for first content without being performed for each content. From second content, a nextTokenID value may be received from a pre-generated smart contract and the value may be predicted.

Accordingly, according to an embodiment of the specification, from second content, because “Blockchain Network”, “Contract Address”, and “nextTokenID” may be known, a lazy minting process may be omitted, and a code (e.g., invisible or visible) may be generated with “Blockchain Network”, “Contract Address”, and “nextTokenID” and may be applied to content. Next, as described above, the content may be uploaded to an IPFS and may be used as metadata to perform minting.

When nextTokenID predicted as above is applied to a plurality of pieces of content, there is a risk that the nextTokenID will be used repeatedly. In order to prevent such redundancy, nextTokenID locking or mutual exclusion technology of the DB concept may be applied to maintain data integrity. For example, the invisible code information may be the IC 312, and thus, the first content may be the NFO 310 to which the IC 312 is applied.

Next, the computing device 200 may upload the first content to which the temporary NFT address information is applied (i.e., the content for proof of ownership) to an IPFS-based shared network (S105). In detail, an IPFS address may be obtained by uploading the temporary NFT address information described in specific content itself and meta information for the specific content (e.g., copyright information and detailed information about media) to the IPFS at once.

Next, identification information of the content for proof of ownership according to the IPFS uploading may be obtained (S107). In more detail, final minting may be performed by inputting the obtained IPFS information to a blockchain.

As described above, the interplanetary file system (IPFS) is a network file sharing system protocol and includes a peer-to-peer network for sharing and storing data in a distributed file system. The IPFS uses content addressing to identify each file in a global namespace that connects all computing devices.

Accordingly, when the content for proof of ownership is uploaded to the IPFS, identification information of the content for proof of ownership including a hashed value is generated according to content addressing. For example, the content for proof of ownership uploaded to the IPFS may be converted into first content identification information (CID) expressed in content-based numbers and letters such as “QmX oypizjW . . . ”. Because the IPFS is configured so that information may be found based on content rather than page location, the content identification information and the content for proof of ownership may be distributed and shared in a peer-to-peer manner to and by numerous computers spread around the world, allowing free access to data and ensuring the proof of original content.

For example, when there exists an URL including the CID indicating the content for proof of ownership on the IPFS system, because new content addressing should be performed when the content is modified/changed, a CID by new hash processing is issued and another URL is allocated. Accordingly, the uniqueness of the content for proof of ownership and the NFT address information may be proven by the identity of the CID. That is, as long as the IPFS-based sharing system established by a global network exists, the proof of the original and ownership of the first content may be permanently proven.

Also, because content on each IPFS system may be divided into several blocks, CIDs may be allocated to folder structures and all files, and interrelated processing is possible, verification is performed by a peer-to-peer system and thus, may be easily linked to a blockchain system.

Accordingly, the computing device 200 determines a final NFT address by minting the content for proof of ownership based on the identification information of the content for proof of ownership (S109). As described above, the NFT address information may be blockchained by the lazy minting protocol.

In this way, the temporary NFT address information shared on the IPFS and the identification information of the content for proof of ownership according to the IPFS may be included in issuance information of an NFT issued later by lazy minting. Accordingly, because the IPFS maintains the identity of the uploaded unique content and the identity of the first NFT address information according to the first owner's pre-minting processing for the first content, which permanently proves the ownership and originality of the first content to the NFT, even when a subsequent transaction is repeatedly performed on a blockchain, the originality may be proven. This blocks the possibility of forgery of the original in an existing NFT issuance method using a content URL, and the effect of reducing an existing transaction fee may also be maintained.

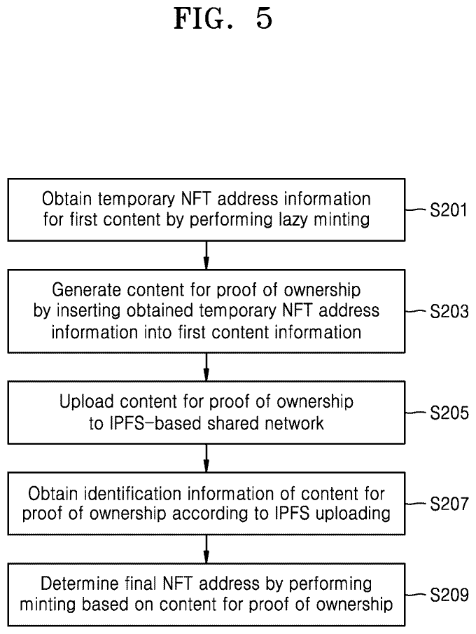

FIG. 5 is a flowchart for describing a method of issuing an NFT which prevents forgery of original content according to an embodiment of the present disclosure. FIG. 5 is a specific example of the method of issuing an NFT described with reference to FIG. 4, and the present disclosure is not limited thereto.

Referring to FIG. 5, a step of obtaining temporary NFT address information for first content by performing lazy minting may be performed (S201), and then content for proof of ownership may be generated by inserting the obtained temporary NFT address information into first content information (S203). The content for proof of ownership into which the temporary NFT address information is inserted (file or Internet address) may be uploaded to an IPFS-based shared network (S205). Identification information for the content for proof of ownership may be generated and obtained according to the IPFS uploading (S207), and a computing device may perform minting based on the obtained identification information (S209).

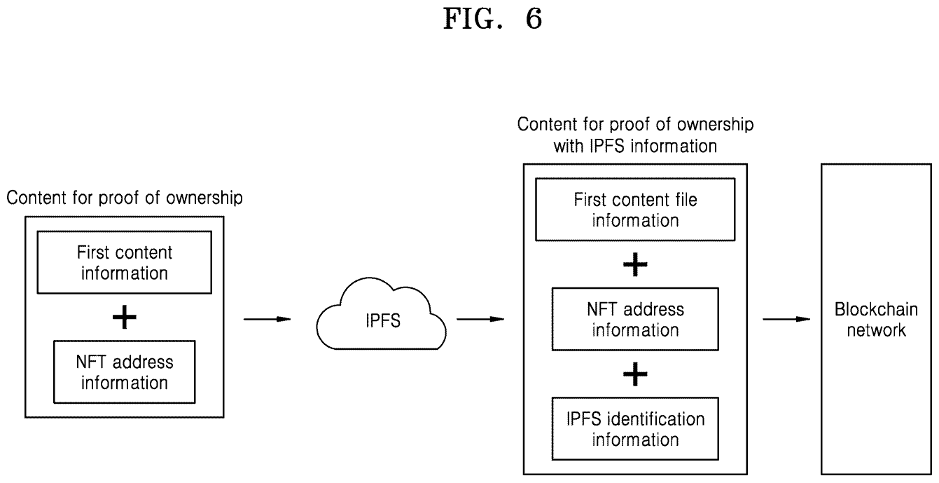

FIG. 6 is a diagram for describing a process according to lazy minting of lazy first content and IPFS application according to an embodiment of the present disclosure. Referring to FIG. 6, as described above, there may be first content information, and the first content information may be a file or a file address. Temporary NFT address information issued after lazy minting may be inserted (added) into the first content information. Content for proof of ownership may be uploaded to an IPFS network to obtain the content for proof of ownership with IPFS information. A computing device may finally determine NFT address information for the first content by registering (performing minting) the content for proof of ownership with the IPFS information in a blockchain network.

Accordingly, the pre-minted NFT address information and IPFS identification information may be included in the first content, and forgery of the first content may be fundamentally impossible.

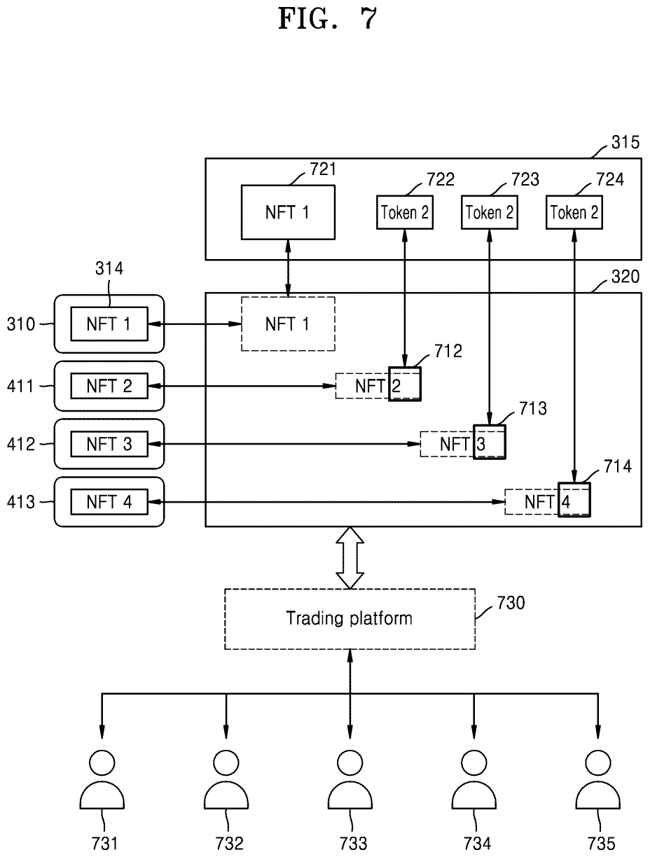

FIG. 7 is a diagram illustrating a method of managing an original NFT and an additional NFT through a service platform according to an embodiment of the specification. As described above, the NFT 314 associated with the NFO 310 to which an IC is applied may be generated. For example, each NFT 314 may be generated by applying the IC to crops, paper, ceramic, or any of various types of real or digital works as the NFO 310. Each NFT 314 may be associated with the service platform 320 through a device. For example, the device may be a device of an owner who performs original verification on the NFO 310. In a specific example, the service platform 320 may perform original verification on an object based on user information for the device. For example, there is a need to prevent the object stolen by another person from being associated with the service platform 320, and the service platform 320 may authenticate user information of the device by considering the above points. That is, an object to which the IC 312 is applied is the NFO 310 based on the ILC 313 and may be registered in the service platform 320 by reflecting user information as the original owner.

In still another example, the service platform 320 may register the NFT 314 corresponding to the NFO 310 based on the IL C 313, without reflecting user information. That is, only original verification may be performed without reflecting user information. For example, the service platform 320 may register the NFT 314 when verification of the originality of the NFO 310 is completed regardless of the owner of the NFO 310, but the present disclosure is not limited thereto.

Also, referring to FIG. 7, the NFT 314 may be generated based on the NFO 310 to which the ILC 313 is applied and may be controlled through the service platform 320, as described above. For example, the NFT 314 may be the original NFT 314 as an NFT for the owner (or owner account) 315 for the NFO 310 as described above. Also, for example, additional NFTs 411, 412, 413 based on additional digital objects may be generated as secondary works for the original, and the additional NFTs 411, 412, 413 may also be controlled through the service platform 320.

For example, the original NFT 314 is an NFT for the NFO owner, may be held only by the owner 315, and may be changed by the acquisition or transfer of the NFO 310. In still another example, a token based on the original NFT 314 may be generated and may be airdropped to the owner account. For example, the owner (or owner account) 315 may transfer or sell the airdropped original NFT 314, but may not be limited thereto.

In still another example, a token may be generated for each of the additional NFTs 411, 412, 413. Because the additional NFTs 411, 412, 413 are associated with the original NFT 314, at least some of tokens 712, 713, 714 issued for the respective additional NFTs 411, 412, 413 may be automatically airdropped to the owner (owner device or owner account) 315 of the original NFT 314. For example, the airdrop may be provided to the account of the owner 315, and may not be limited by a device of the owner 315. That is, because the additional NFTs 411, 412, 413 based on the original NFT 314 are associated with the original NFT 314, some of the tokens 711, 713, 714 issued for the respective additional NFTs 411, 412, 413 may be provided to the owner account of the original NFT 314. Accordingly, the owner account may hold tokens 722, 723, 724 based on the additional NFTs 411, 412, 413 and an original NFT 721. Next, the rest of the tokens 712, 713, 714 issued for the respective additional NFTs 411, 412, 413 may be traded through a trading platform 730. A value (or price) may be determined by traders (or trader accounts) 731, 732, 733, 734, 735 who purchase a corresponding token through the trading platform 730.

In a specific example, the original NFT 314 may be an NFT corresponding to the object 311, and the NFT may be associated with the transfer of the object 311 and thus, it may not be easy to trade with only the NFT. For example, based on an actual transaction of the object 311, the original NFT 314 needs to be transferred from a previous owner account to a buyer account. Considering the above points, there may be limitations in issuing a token based on the original NFT 314 and trading through the trading platform 730. On the other hand, additional NFTs based on the original NFT are associated with the object 311 and may be traded regardless of the purchase and sale of the object 311. Because the additional NFTs are associated with the original NFT 314, values (or prices) of tokens based on the additional NFTs may also be linked to the original NFT 314. That is, although the object 311 is not frequently traded due to its high unit price and it is not easy to find a counterparty to trade with, a digital object is easily traded through the NFT market, making it possible to easily and accurately estimate a market price, which may serve as a measure for determining a value of the original.

In a specific example, the owner of the object 311 may be changed. For example, when the owner (or owner account) 315 of the object 311 is changed to a new owner (or owner account), the service platform 320 may record owner change information of the NFO 310 and the original NFT 314 on a blockchain network. The service platform 320 may change only the original NFT 314 to the new owner (or owner account) without changing tokens for the additional NFTs, and may record the changed information on the blockchain network.

Also, the service platform 320 may record transaction information on the blockchain as information in which the additional NFTs are traded on the trading platform 730. The service platform may automatically generate value information of the NFO based on the recorded transaction information for the additional NFTs and may record the value information on the blockchain network.

Also, for example, the number of additional NFTs may be limited based on the original NFT 314. That is, the number of digital objects may be limited based on secondary works. For example, when the number of additional digital objects is not limited based on secondary works, the relevance to the original may be reduced, and thus, considering the above points, the number of additional digital objects may be limited based on secondary works and the number of additional NFTs may also be limited based on secondary works. Next, the service platform 320 may monitor and manage additional NFTs or token value information of the additional NFTs traded through the trading platform 730.

Also, for example, the NFO owner 315 may transfer the NFO 310 to another user. The NFO 310 may be proven to be the original based on the service platform 320. Accordingly, when the NFO 310 is transferred, it may be necessary to check whether the owner is changed through the service platform 320. Considering the above points, there is a need to perform a transaction between a transferor (original owner) and a transferee based on the service platform 320. In detail, when the transferee and the transferor perform a transaction for the NFO 310, the transferee may photograph the NFO 310 and may perform a transferee application for the NFO 310 to the service platform 320. The service platform 320 may check the transferor whether the transfer is made, and when the transfer is made, the service platform 320 may change the owner from the original NFT 314 based on the IL C 313 to the transferee and may recording corresponding information on the blockchain. However, even in the above case, a change for the additional NFTs may not be necessary.

The embodiments described hereinabove may be implemented, at least in part, in a computer program and recorded on a computer-readable recording medium. The computer-readable recording medium in which the program for embodying the embodiments is recorded includes any type of recording device in which computer-readable data is stored. Examples of the computer-readable recording medium include ROM, RAM, CD-ROM, magnetic tape, and an optical data storage device. Additionally, the computer-readable recording medium is distributed over computer systems connected via a network, and may store and execute a computer-readable code in a distributed manner. Additionally, a functional program, code and a code segment for realizing this embodiment will be easily understood by persons having ordinary skill in the technical field to which this embodiment belongs.

While the present disclosure has been hereinabove described with reference to the embodiments shown in the drawings, this is provided for illustration purposes only and it will be appreciated by those having ordinary skill in the art that a variety of modifications and variations may be made thereto. However, it should be noted that such modifications fall within the technical protection scope of the present disclosure. Therefore, the true technical protection scope of the present disclosure will be construed as including other implementations, other embodiments and the appended claims and their equivalents by the technical spirit of the appended claims.

What is claimed is:

1. A method of securing media content by using lazy minting of a blockchain, an interplanetary file system (IPFS), and a digital watermark, performed by a computing device, the method comprising:
uploading content to an IPFS-based shared network;
obtaining content identification information according to IPFS uploading of the content;
applying the content identification information to the content; and
determining non-fungible token (NFT) address information by minting the content to which the content identification information is applied.

2. The method of securing media content by using lazy minting of a blockchain, an IPFS, and a digital watermark according to claim 1, before the uploading, the method further comprising generating content for proof of ownership by applying temporary NFT address information obtained through lazy minting to the content,
wherein the content for proof of ownership is uploaded to the IPFS.

3. The method of securing media content by using lazy minting of a blockchain, an IPFS, and a digital watermark according to claim 2, wherein the content identification information comprises address information on an IPFS network configured according to hash conversion of the content for proof of ownership.

4. The method of securing media content by using lazy minting of a blockchain, an IPFS, and a digital watermark according to claim 2, wherein the content for proof of ownership comprises invisible code information applied to an object of the content.

5. The method of securing media content by using lazy minting of a blockchain, an IPFS, and a digital watermark according to claim 2, wherein the content for proof of ownership is configured by inserting the temporary NFT address information and invisible code information configured from first content into the content.

6. The method of securing media content by using lazy minting of a blockchain, an IPFS, and a digital watermark according to claim 2, wherein the determining of the NFT address information by minting the content to which the content identification information is applied comprises determining a final NFT address by performing minting based on identification information generated by uploading the content for proof of ownership to the IPFS.
